(19) United States
(12) Patent Application Publication
(10) Pub. No.: US 2009/0243503 A1
(43) Pub. Date: Oct. 1, 2009

(54) DISCHARGE LAMP LIGHTING DEVICE

(75) Inventor: Akio Iwao, Ehime (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HARISON TOSHIBA LIGHTING CORP., EHIME (JP)

(21) Appl. No.: 12/374,001

(22) PCT Filed: May 30, 2007
(86) PCT No.: PCT/JP07/61015

§ 371 Date: Jan. 15, 2009

(30) Foreign Application Priority Data
Jul. 20, 2006 (JP) 2006-198591
Sep. 26, 2006 (JP) 2006-260565
Sep. 26, 2006 (JP) 2006-260566

(51) Int. Cl. H05B 41/14

(52) U.S. Cl. 315/246

(57) ABSTRACT

A discharge lamp lighting device includes: a first series circuit unit in which a primary coil is connected in series to a capacitor; a second series circuit unit in which a secondary coil is connected in series to a discharge lamp, the secondary coil being a winding wound on the side portion of a rod-shaped magnetic core along the axial direction of the magnetic core, being greater in the number of turns than the primary coil, being smaller in dimension of its cross section parallel to the axial direction of the magnetic core than in dimension of its cross section in the radial direction of the magnetic core and forming a transformer along with the primary coil; and a bridge DC-AC converting circuit which includes four transistors, converts DC voltage supplied from a power supply unit to AC voltage and supplies the AC voltage to both ends of the first and the second series circuit units connected in parallel to each other, and the discharge lamp lighting device being capable of generating voltage by a small and simple circuit at the time of starting the lamp and performing preheating control.

### TECHNICAL FIELD

The present invention relates to a discharge lamp lighting device.

### BACKGROUND ART

A high intensity discharge (HID) lamp such as a metal halide lamp with a high efficiency and high intensity has been used hitherto for exterior lighting such as road lighting and as a light source of a projection device such as a digital light processing (DLP) and a liquid crystal projector.

As a conventional discharge lamp lighting device configured to light an HID lamp, a discharge lamp lighting device using a starter has been known disclosed in, for example, Japanese Unexamined Patent Application Publication No. 2005-507553 (hereinafter referred to as Patent Document 1).

The device disclosed in Patent Document 1 supplies a lamp with such a square wave voltage with a comparatively small amplitude and a comparatively low frequency as continuously causes an arc discharge in the lamp and with a voltage with a comparatively high frequency at which a coil and a capacitor are electrically resonated at the time of starting the device. The device in Patent Document 1 is capable of supplying the lamp with a comparatively high voltage at the time of starting and a voltage sustaining a normal lighting of the lamp.

In order to increase a voltage across a capacitor of a general series resonance circuit, such conditions are required as a large inductance, a small electrostatic capacity and a small parasitic resistance. The device in Patent Document 1 is further subjected to a condition that a bridge is driven at a high frequency, and therefore cannot provide a voltage high enough to start the device. For this reason, it may take a long time for the device in Patent Document 1 to light the lamp again or it is required to separately prepare a circuit configured to generate a higher voltage to start the device.

Furthermore, the number of turns of a secondary coil of a transformer used in a booster circuit has to be increased to generate a high voltage. Still furthermore, in order to ensure insulation against a high generated voltage, a spatial distance and a creeping distance need to be ensured between the ends where the secondary coil of the transformer starts to be wound and finishes being wound. The secondary coil needs winding in one direction in a single layer fashion. As a result, the transformer becomes larger.

An object of the present invention is to provide a discharge lamp lighting device capable of generating a comparatively high voltage at the time of starting the lamp using a small and simple circuit and performing a preheating control.

### DISCLOSURE OF INVENTION

### Means for Solving the Problem

A discharge lamp lighting device according to one aspect of the present invention includes: a first series circuit unit in which a primary coil is connected in series to a capacitor; a second series circuit unit in which a secondary coil is connected in series to a discharge lamp, the secondary coil being a winding wound on the side portion of a rod-shaped magnetic core along the axial direction of the magnetic core, being greater in the number of turns than the primary coil, being smaller in dimension of its cross section parallel to the axial direction of the magnetic core than in dimension of its cross section in the radial direction of the magnetic core and forming a transformer along with the primary coil; and a bridge DC-AC converting circuit which includes four transistors, converts DC voltage supplied from a power supply unit to AC voltage and supplies the AC voltage to both ends of the first and the second series circuit units connected in parallel to each other.

Furthermore, a discharge lamp lighting device according to one aspect of the present invention includes: a first circuit unit including a first primary coil, a second primary coil and a first capacitor which are connected in series to one another; a second circuit unit in which a first secondary coil is connected in series to a discharge lamp, the first secondary coil forming a transformer along with the first primary coil and being greater in the number of turns than the first primary coil; a DC-AC converting circuit configured to convert DC voltage supplied from a power supply unit to AC voltage and supply the AC voltage to both ends of the first and the second circuit unit connected in parallel to each other; a second secondary coil which is included in the first circuit unit, forms a transformer along with the second primary coil and is greater in the number of turns than the second primary coil; a second capacitor which is included in the first circuit unit and to which the voltage generated in the second secondary coil is applied through a charging path; and a discharge gap which is included in the first circuit unit, conducted by the terminal voltage of the second capacitor reaching the discharge gap voltage and supplies the terminal voltage of the second capacitor to the first primary coil through a discharging path.

Still furthermore, a discharge lamp lighting device according to one aspect of the present invention includes: a first circuit unit configured to generate a desired voltage as polarity is reversed to supply the voltage to a primary coil; a second circuit unit formed in such a manner that a secondary coil forming a transformer along with the primary coil and being greater in the number of turns than the primary coil is connected in series to a discharge lamp, and connected in parallel to the first circuit unit; a DC-AC converting circuit configured to convert DC voltage supplied from a power supply unit to AC voltage and supply the AC voltage to both ends of the first and the second circuit units connected in parallel to each other; and a control unit configured to control the DC-AC converting circuit to continuously supply the AC voltage to the first circuit unit.

### BRIEF DESCRIPTION OF THE DRAWINGS

FIG. 1 is a circuit diagram illustrating a discharge lamp lighting device according to a first embodiment of the present invention;

FIG. 2 is a schematic diagram in which a transformer T according to the first embodiment is viewed from the axial direction of the magnetic core;

FIG. 3 is a cross-sectional diagram taken along line III-III in FIG. 2;

FIG. 4 is a schematic diagram illustrating a modification of a ferrite core;

FIG. 5 is a flow chart describing the operation of the embodiment;

FIG. 6 is a waveform chart illustrating a voltage (a no-load starting voltage) across the lamp 12 at the time of starting with the abscissa as time and the ordinate as voltage;

FIG. 7 is a waveform chart with the time base being 10 times greater than that in FIG. 6;

FIG. 8A is a waveform chart illustrating variation in lamp current at the time of preheating with the abscissa as time and the ordinate as current;

FIG. 8B is a waveform chart illustrating variation in lamp current at the time of preheating with the abscissa as time and the ordinate as current;

FIG. 9A is a waveform chart with the time base of FIG. 8 expanded;

FIG. 9B is a waveform chart with the time base of FIG. 8 expanded;

FIG. 10 is a circuit diagram illustrating a modification of the first embodiment;

FIG. 11 is a circuit diagram illustrating a second embodiment of the present invention;

FIG. 12 is a cross-sectional diagram illustrating a coil of the second embodiment;

FIG. 13 is a circuit diagram illustrating a modification of the second embodiment;

FIG. 14 is a circuit diagram illustrating a third embodiment of the present invention;

FIG. 15 is a cross-sectional diagram illustrating a coil of the third embodiment;

FIG. 16 is a circuit diagram illustrating a modification of the third second embodiment;

FIG. 17 is a circuit diagram illustrating a discharge lamp lighting device according to a fourth embodiment of the present invention;

FIG. 18 is a circuit diagram illustrating one of concrete examples of a first-stage booster circuit 14 in FIG. 17;

FIG. 19 is a waveform chart illustrating a voltage (a no-load starting voltage) across a lamp 12 at the time of starting with the abscissa as time and the ordinate as voltage;

FIG. 20 is a waveform chart illustrating a voltage waveform (a high voltage starting waveform) in the lamp 12 in a high voltage starting term of FIG. 19;

FIG. 21 is a waveform chart illustrating a voltage waveform (a low voltage starting waveform) in the lamp 12 in a low voltage starting term of FIG. 19;

FIG. 22 is a circuit diagram illustrating a modification of the fourth embodiment;

FIG. 23 is a circuit diagram illustrating a fifth embodiment of the present invention;

FIG. 24 is a circuit diagram illustrating a modification of the fifth embodiment;

FIG. 25 is a circuit diagram illustrating a discharge lamp lighting device according to a sixth embodiment of the present invention;

FIG. 26 is a circuit diagram illustrating one of concrete examples of a first-stage booster circuit 140 in FIG. 25;

FIG. 27 is a waveform chart illustrating the voltage across the lamp 12 at the time of starting with the abscissa as time and the ordinate as voltage;

FIG. 28 is a circuit diagram illustrating a first modification of the embodiment in FIG. 25;

FIG. 29 is a circuit diagram illustrating a second modification of the embodiment in FIG. 25; and

FIG. 30 is a circuit diagram illustrating a third modification of the embodiment in FIG. 25;

### BEST MODE FOR CARRYING OUT THE INVENTION

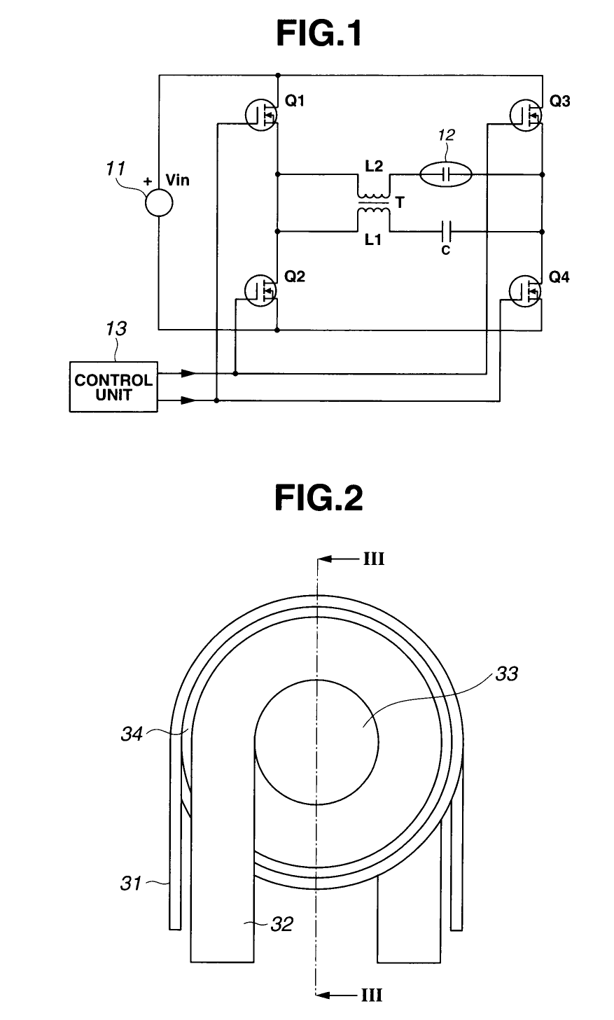

An embodiment of the present invention is described below in detail with reference to the drawings. FIG. 1 is a circuit diagram illustrating a discharge lamp lighting device according to a first embodiment of the present invention.

A power supply unit 11 generates a DC voltage. The power supply unit 11 delivers a constant electric power. Specifically, the power supply unit 11 may be configured by, for example, an output smoothing capacitor of a constant-power control chopper circuit.

The positive polarity output terminal of the power supply unit 11 is connected to the drains of transistors Q1 and Q3 through a power supply line. The negative polarity output terminal of the power supply unit 11 is connected to the sources of transistors Q2 and Q4 through a reference potential line. The source of the transistor Q1 is connected together to the drain of the transistor Q2. The source of the transistor Q3 is connected together to the drain of the transistor Q4.

The transistors Q1 to Q4 form a bridge DC-AC converting circuit which converts a DC voltage from the power supply unit 11 to an AC voltage.

A node (hereinafter referred to as a first node) between the source of the transistor Q1 and the drain of the transistor Q2 is connected to a node (hereinafter referred to as a second node) between the source of the transistor Q3 and the drain of the transistor Q4 through a first series circuit formed by a coil L1 and a capacitor C. A second series circuit formed by a coil L2 and a lamp 12 is connected between the first and the second nodes. An HID lamp is used as the lamp 12.

The capacitor C is provided to produce an oscillating waveform and limit current. The coils L1 and L2 form a transformer T. Incidentally, the coil L1 is taken as a primary of the transformer T and the coil L2 is taken as a secondary of the transformer T. In the present embodiment, the number of turns of the coil L2 is n times as many as that of the coil L1 (n is a positive number). The turns ratio “n” ranges from several times to several hundred times, for example.

A control unit 13 generates a control signal configured to drive the transistors Q1 to Q4. The control unit 13 turns on the transistors Q1 and Q4 and turns off the transistors Q2 and Q3. The control unit 13 turns off the transistors Q1 and Q4 and turns on the transistors Q2 and Q3. The control unit 13 varies an on-off switching frequency (a driving frequency) of the transistors Q1 to Q4 according to each phase at the time of lighting the lamp 12.

In other words, in the present embodiment, the control unit 13 drives the transistors Q1 to Q4 with a comparatively high frequency at the time of starting and preheating and drives the transistors Q1 to Q4 with a comparatively low frequency at the time of normal lighting.

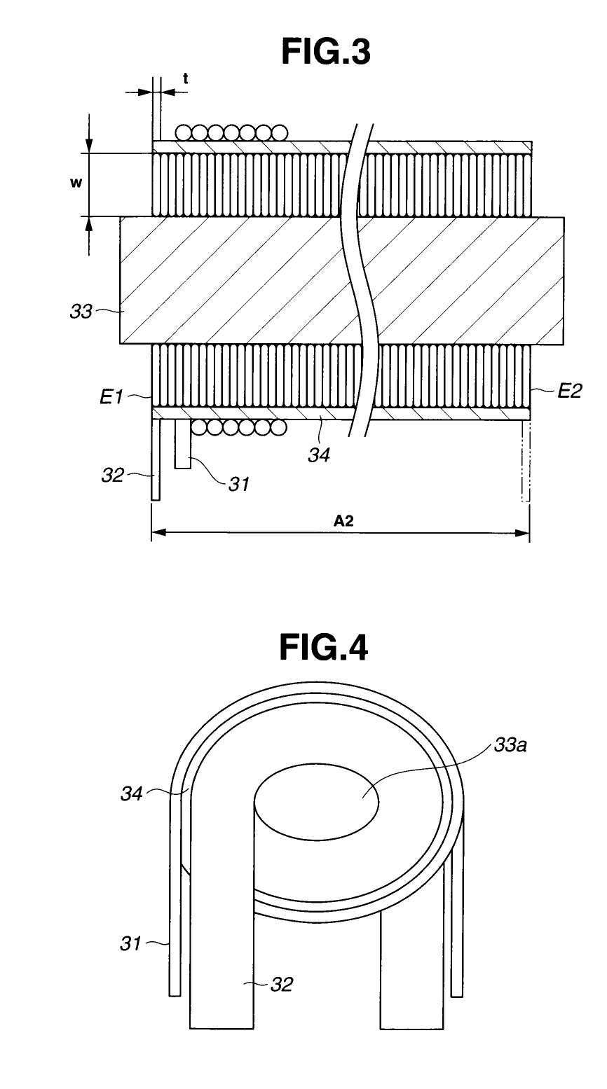

The configuration of the transformer T according to the present embodiment is described with reference to FIGS. 2 and 3. FIG. 2 is a schematic diagram in which the transformer T according to the first embodiment of the present invention is viewed from the axial direction of the magnetic core thereof. FIG. 3 is a cross-sectional diagram taken along line III-III in FIG. 2.

As illustrated in FIG. 2, the transformer T according to the present embodiment is configured such that a secondary winding 32 and a primary winding 31 being an insulated conductive wire, so-called magnet wire are wound on the side portion of a ferrite core 33 being a rod-shaped magnetic core of a magnetic material in a single layer fashion. The secondary winding 32 and the primary winding 31 form the coil L2 being the secondary coil and the coil L1 being the primary coil, respectively.

As illustrated in FIG. 3, the secondary winding 32 is a copper wire rod formed in a substantially rectangular and flat shape in cross section by rolling or drawing. In other words, the secondary winding 32 has two parallel faces on its sides. A wire rod having a cross-sectional shape like the secondary winding 32 of the present embodiment is generally referred to as a rectangular wire. Hereinafter, the dimension in the longitudinal direction of the cross-sectional shape of conductive portion of the secondary winding 32 is referred to as width “W” and the dimension in the widthwise direction thereof is referred to as thickness “t.”

The secondary winding 32 is wound on the side of the ferrite core 31 in a single layer fashion such that the longitudinal direction of the cross-sectional shape is along the radial direction of the ferrite core 31. A method of winding the rectangular wire in the present embodiment is generally referred to as edgewise winding or widthwise winding. Thus winding the secondary winding 32 in one direction in a single layer fashion ensures a spatial distance and a creeping distance between both the ends E1 and E2 of the coil L2 and sufficient insulation against a voltage generated by the transformer T. In the present embodiment, the number of turns of the secondary winding 32 is 200. The cross section of the conductive portion is 3.8 mm in width W and 0.2 mm in thickness t. The dimension A2 of the coil L2 in the axial direction of the ferrite core 33, i.e., the distance between both the ends E1 and E2 of the coil L2 is 27 mm.

The primary winding 31 configuring the coil L1 is wound around the outer periphery of the coil L2 formed of the secondary winding being the edgewise wound rectangular wire in the axial direction of the ferrite core 33 in a single layer fashion. The primary winding 31 is a wire rod which is circular in the cross section of the conductive portion thereof. In the present embodiment, the number of turns of the primary winding 31 is 7, for example. The conductive portion is 0.4 mm in diameter. An insulating material 34 formed of a material with insulation is set between the secondary winding 32 and the primary winding 31.

Although the ferrite core 33 is a solid cylindrical member with a circular cross section illustrated in FIGS. 2 and 3, the ferrite core 33 may be quadrangular or elliptical in cross section, or may be a hollow cylindrical member. For example, as illustrated in FIG. 4, the cross-section of the ferrite core 33a is made elliptical to enable the transformer T to decrease in its height.

According to the transformer T of the present embodiment, the dimension A2 of the coil L2 in the axial direction of the ferrite core 33 can be decreased as compared with the case where a magnet wire which is round in cross section and equal in cross section to the secondary winding 32 is wound in the axial direction of the ferrite core 33 in a single layer fashion with the same number of turns as the secondary winding 32.

For example, the magnet wire which is round and equal in cross section to the secondary winding 32 according to the present embodiment is 0.7 mm in diameter of its conductive portion. A coil in which the magnet wire round in cross section is wound with 200 turns in a single layer fashion is as long as 140 mm or more in dimension in the axial direction of the ferrite core. On the other hand, in the present embodiment, the coil L2 is 27 mm in the dimension A2 in the axial direction of the ferrite core 33.

According to the present embodiment, winding the secondary winding 32 in one direction in a single layer fashion ensures a high insulation and decreases the dimension A2 of the coil L2 in the axial direction of the ferrite core 33 without decreasing the cross section of the secondary winding 32, thereby downsizing the transformer T.

The shape of the ferrite core 33, and the width W and the thickness t of conductive portion of the secondary winding 32 and the ratio therebetween are selected according to the configuration of the discharge lamp lighting device of the present embodiment including the transformer T and are not limited to the above values.

It is needless to say that the conductive portion of the secondary winding 32 which is elliptical, oblong or of a similar flat shape thereof as well as rectangular in cross section provides the same effect. If the conductive portion of the secondary winding 32 is square in cross section and if the secondary winding 32 is wound such that the inner face of the conductive portion is made parallel to the side portion of the ferrite core 33, the dimension A2 of the coil L2 in the axial direction of the ferrite core 33 can be reduced as is the case with the above configuration, providing the same effect.

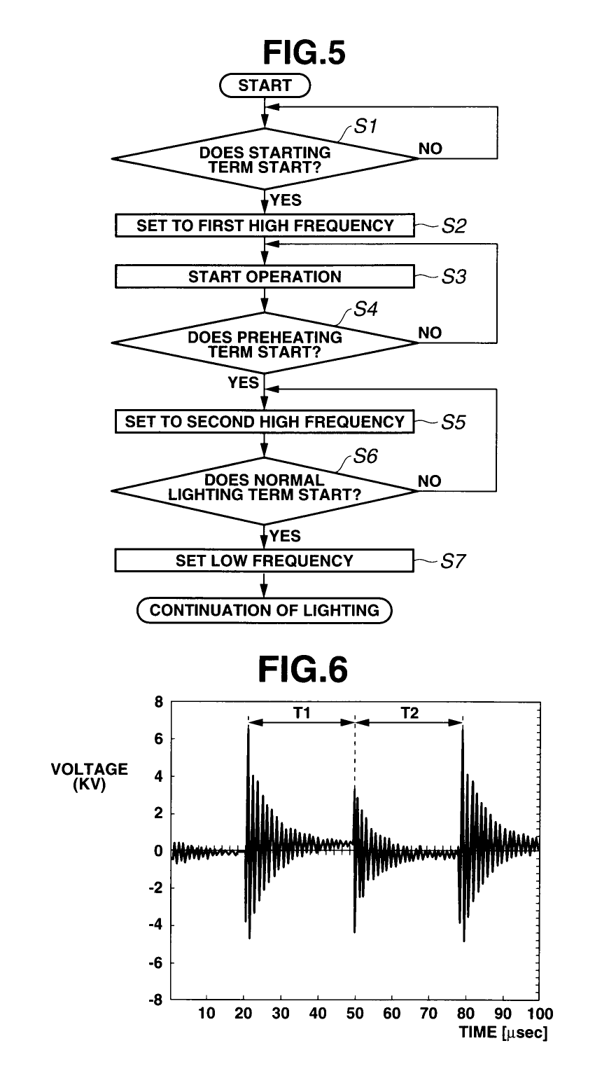

The operation of the embodiment thus configured is described below with reference to FIGS. 5 to 9B. FIG. 5 is a flow chart describing the operation of the embodiment.

### <Starting>

The power supply unit 11 supplies a positive polarity output to the power supply line and a negative polarity output to the reference potential line. A DC voltage applied across the power supply line and the reference potential line is supplied to the transistors Q1 to Q4 forming the bridge DC-AC converting circuit.

At the time of starting lighting the lamp 12, the process proceeds from step S1 to step S2 in FIG. 5 and the control unit 13 sets a first high frequency as the driving frequency of the transistors Q1 to Q4. The control unit 13 supplies the transistors Q1 to Q4 with the control signal with the first high frequency to turn on and off the transistors (step S3).

That is to say, the transistors Q1 and Q4 forming the bridge circuit are turned on and off at the same time, and the transistors Q2 and Q3 are also turned on and off at the same time. When the transistors Q1 and Q4 are turned on, the transistors Q2 and Q3 are turned off. When the transistors Q1 and Q4 are turned off, the transistors Q2 and Q3 are turned on. To prevent short-circuit, all the transistors Q1 to Q4 are turned off for a short time.

When the transistors Q1 and Q4 are turned on, the positive polarity output terminal of the power supply unit 11 causes current to flow to the negative polarity output terminal through the transistor Q1, the coil L1, the capacitor C, and the transistor Q4. When the transistors Q2 and Q3 are turned on, on the other hand, the positive polarity output terminal of the power supply unit 11 causes current to flow to the negative polarity output terminal through the transistor Q3, the capacitor C, the coil L1, and the transistor Q2.

When the transistors Q1 and Q4 are turned on, the capacitor C is charged through the coil L1 to increase the terminal voltage of the capacitor C substantially to the voltage Vin of the power supply unit 11. Then, a voltage VL generated by counter electromotive force in the coil L1 is added to the voltage Vin to increase the terminal voltage of the capacitor C to Vin+VL. A free oscillation is generated between the coil L1 and the terminal voltage of the capacitor C converges at a predetermined value while changing polarities. When the transistors Q2 and Q3 are turned on, the same operation is performed as in the case where the transistors Q1 and Q4 are turned on.

In the present embodiment, a voltage generated in the coil L1 generates a high voltage in the coil L2 according to the turns ratio. The voltage generated in the coil L2 has substantially the same waveform as the voltage generated in the coil L1 and the capacitor C and is large enough in amplitude according to the number of turns. The voltage generated in the coil L2 is applied to the lamp 12.

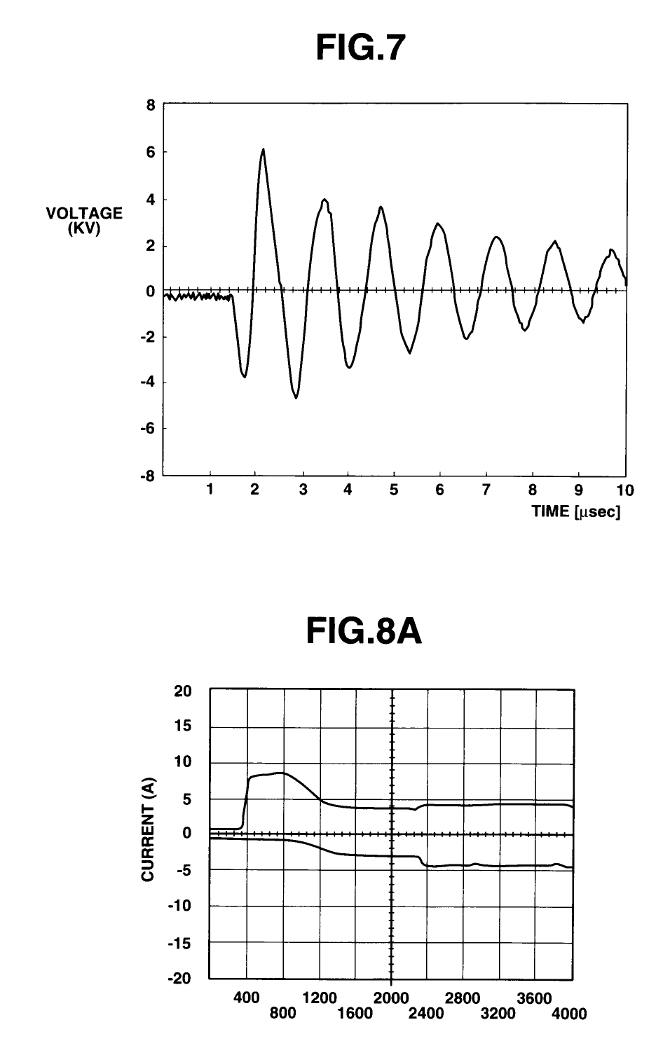

FIG. 6 is a waveform chart illustrating a voltage (a no-load starting voltage) across the lamp 12 at the time of starting with the abscissa as time and the ordinate as voltage. FIG. 7 is a waveform chart with the time base being 10 times greater than that in FIG. 6. In FIG. 6, a term T1 is a term during which the transistors Q1 and Q4 are turned on. A term T2 is a term during which the transistors Q2 and Q3 are turned on.

As illustrated in FIG. 6, an extremely high voltage is generated across the lamp 12 when the transistors Q1 and Q4 start to turn on and the transistors Q2 and Q3 start to turn on. FIG. 6 illustrates a characteristic obtained when a driving frequency of the transistors Q1 to Q4 is set to 17 kHz with Vin being 220 V, L1 being 2.1 μH and seven turns, L2 being 1.3 mH and 200 turns and C being 0.01 μF. In the example of FIG. 6, the maximum voltage across the lamp 12 is approximately 6640 V and the minimum voltage is approximately −4800 V. The high voltage is applied to the lamp 12 each time the polarity of full bridge drive is reversed. Frequencies of several hundred Hz to several hundred kHz may be used as the driving frequency at the time of starting.

Thus, turning on and off the transistors Q1 and Q4 and the transistors Q2 and Q3 is driven by the first high frequency to apply a high oscillation voltage to the lamp 12.

As can be seen from FIG. 7, the voltage waveform applied to the lamp 12 is a damping oscillation waveform with comparatively little distortion.

Thus, at the time of starting, the coil L1 and the capacitor C cause a free oscillation when the polarity of the full bridge is reversed. At the time of the free oscillation, the voltage applied to the coil L1 is induced to the coil L2 according to the turns ratio of the coil L2 to the coil L1. As described above, the free oscillation in the first series circuit converges before the next reversion of the polarity to reduce current to substantially zero.

### <Preheating>

The high voltage induced in the coil L2 is applied to the lamp 12 to cause the dielectric breakdown in the lamp 12. When the lamp 12 causes the dielectric breakdown by controlling the starting term, the lamp proceeds to a preheating term (step S4). The preheating term is a term during which an unstable discharge state immediately after discharge is started is transferred to stable discharge state.

The dielectric breakdown triggers off the glow discharge of the lamp 12 then, to cause arc discharge, leading to normal lighting state. In the present embodiment, the lamp 12 is lighted by the energy of the power supply unit 11 during all the terms of the starting term, the preheating term and the normal lighting term.

At the time of preheating, a larger amount of lamp current is caused to flow to the lamp 12 to provide a stable discharge state in a short time. However, a large amount of lamp current damages the electrode of the lamp 12. For this reason, it is desirable to make a lamp current controllable at the time of preheating. In the present embodiment, the driving frequency of the transistors Q1 to Q4 is controlled to perform a preheating control.

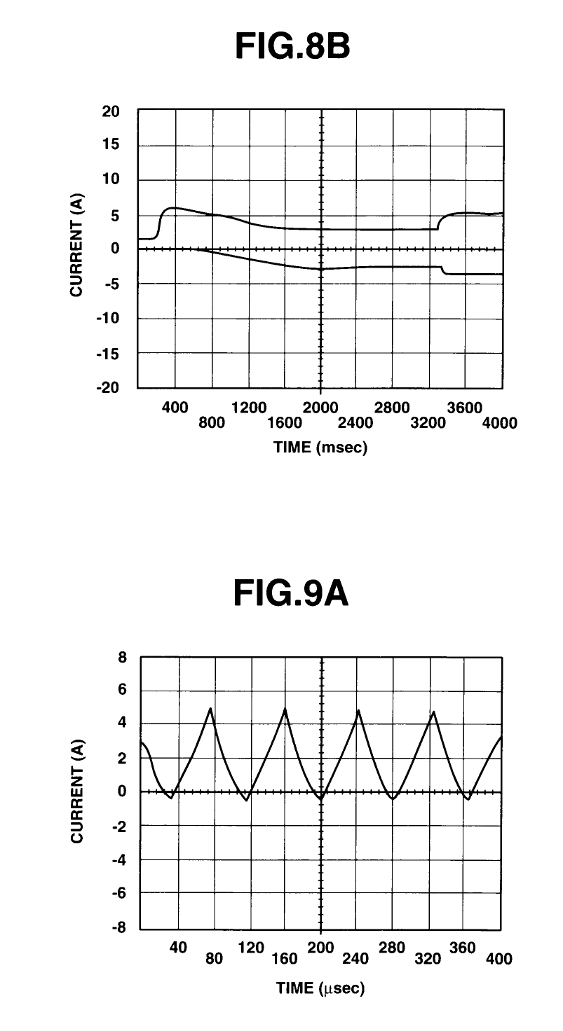

FIGS. 8A and 8B are waveform charts illustrating the variation in lamp current at the time of preheating with the abscissa as time and the ordinate as current. FIG. 8A illustrates a characteristic obtained when the driving frequency (preheating frequency) of the transistors Q1 to Q4 is set to 10 kHz at the time of preheating under the same condition as in the example of FIG. 6. FIG. 8B illustrates a characteristic obtained when the driving frequency of the transistors Q1 to Q4 is set to 12 kHz. FIGS. 8A and 8B show examples where the driving frequencies of the transistors Q1 to Q4 are set to be equal to each other at the time of starting and preheating respectively. The characteristics of a lamp current at the time of preheating will be affected by ambient temperature inside the lamp and the like. The characteristics in FIGS. 8A and 8B illustrate examples under specific conditions.

The lamp current becomes not an alternating current but a pulsating flow immediately after the preheating is started in any example of FIGS. 8A and 8B and in any example, not shown, of frequencies of 8 kHz to 15 kHz. Incidentally, the polarity can be reversed by reversely connecting the terminals of the lamp 12 to each other. The pulsating flow immediately after the start of preheating changes to alternating current as time passes. As frequencies increase from 8 kHz to 15 kHz at the time of preheating, a lamp current value decreases at the time of preheating. In addition, as frequencies increase from 8 kHz to 15 kHz at the time of preheating, it takes a longer time for the pulsating flow to change to alternating current. In other words, the smaller the current at the time of preheating, the longer the time during which the pulsating flow changes to alternating current.

Judging from the above, it is probable that unstable discharge is stabilized as time passes immediately after the start of discharge (start of preheating) to change to alternating current. In the preheating term, the larger the lamp current, the faster increase in temperature of inside gas or the electrode, the lamp quickly proceeds to a stable discharging state. The lamp current can be controlled by changing frequencies at the time of preheating.

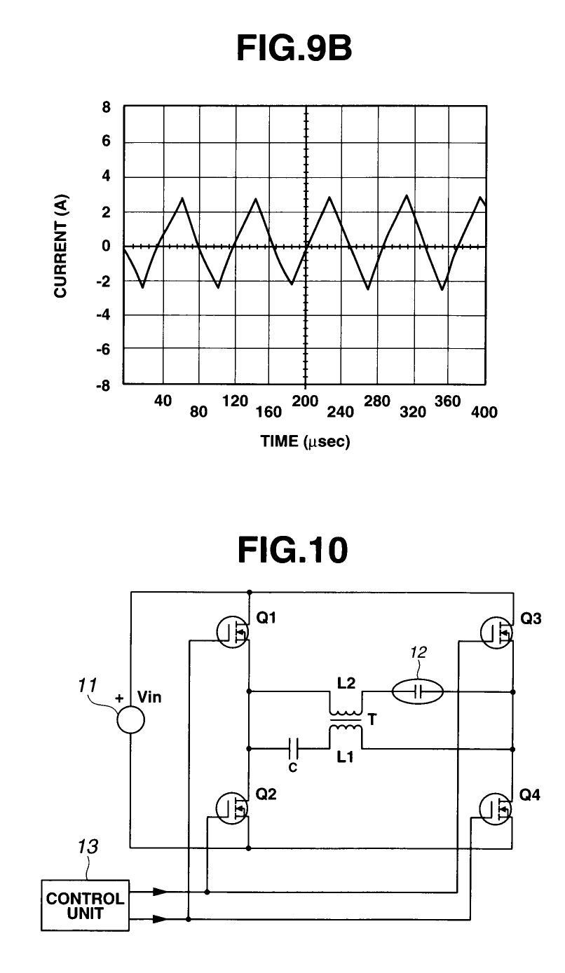

FIGS. 9A and 9B are waveform charts with the time base of FIG. 8B expanded. FIGS. 9A and 9B show examples where the frequency at the time of preheating is 12 kHz. FIG. 9A shows a pulsating-flow interval of FIG. 8B. FIG. 9B shows an alternating-current interval of FIG. 8B.

As illustrated in FIGS. 9A and 9B, the lamp current changes to a sawtooth waveform. The inductance of the coil changes current to a sawtooth waveform. The peak of the current value is determined by the driving frequency of the transistors Q1 to Q4. The lamp current is slightly saturated during the pulsating-flow interval of FIG. 9A. As illustrated in FIG. 9B, sawtooth waveform lamp current with little distortion is obtained during the alternating current interval. The current peak value toward the same direction is smaller during the alternating current interval than during the pulsating-flow interval, so that the lamp current is hard to be saturated.

In the examples of FIGS. 8A and 8B, if a frequency slightly higher than 10 kHz is used as a frequency at the time of preheating, the peak value of the current at the time of preheating may be small and a preheating time may be comparatively long. Thus, properly controlling the frequency at the time of preheating enables preheating without damaging the lamp electrode.

### <Normal Lighting Term>

The preheating is terminated and the lamp is caused to proceed to a normal lighting term. In this case, the control unit 13 causes the process to proceed from step S6 to step S7 and sets the driving frequency of the transistors Q1 to Q4 to the frequency lower than that at the time of starting and preheating. FIGS. 8A and 8B show examples where the driving frequency is 100 Hz in the normal lighting term.

Current flows mainly through the coil L2 and the lamp 12 based on a rectangular waveform voltage generated by the DC-AC converting circuit formed of the transistors Q1 and Q4 in the normal lighting term. Even if the driving frequency becomes low, the capacitor C is connected in series to the coil L1, so that the current will not continue flowing. Since the voltage Vin of the power supply unit 11 becomes low in the normal lighting term, current of the coil L1 is significantly reduced at the time of reversing the polarity. In the normal lighting term, the lamp 12 moves to stable arc discharge, providing stable lamp current.

Thus, in the present embodiment, the first series circuit including the freely-oscillating primary coil and capacitor is connected in parallel to the second series circuit including the secondary coil and the lamp. The bridge DC-AC converting circuit using four transistors applies a rectangular waveform voltage across both ends of the first and the second series circuit. A high voltage can be generated in the secondary coil according to turns ratio of the secondary coil to the primary coil. When the starting term ends and then the preheating term begins, the driving frequency of the transistor is controlled to cause the lamp current to proceed to a stable discharge state without damaging a lamp electrode. For example, in a conventional high-voltage pulse starting system, an uncontrollable lamp rush current flows supplied from the power supply; however, the present embodiment can performs preheating while sufficiently suppressing the lamp rush current. This enables the lifetime of the lamp to be increased.

Thus, in the present embodiment, a comparatively simple circuit with a small transformer enables a high voltage discharge lamp to be started and normally lighted and a single-stage starting circuit is advantageous in terms of downsizing and cost reduction.

The control unit 13 may switch the starting term, the preheating term and the normal lighting term by time since the start of driving, for example.

FIG. 10 is a circuit diagram illustrating a modification of the first embodiment. In FIG. 10, the same composing elements as in FIG. 1 are denoted with the same reference numeral and characters to omit duplicated description.

The example in FIG. 10 arranges the capacitor C that is arranged on one side of the coil L1 in FIG. 1 on the other side the coil L1. In this case also, the first series circuit formed of the capacitor C and the coil L1 operates in the same manner as the capacitor C and the coil L1 in FIG. 1.

The other configuration and action are the same as those described in the embodiment in FIG. 1.

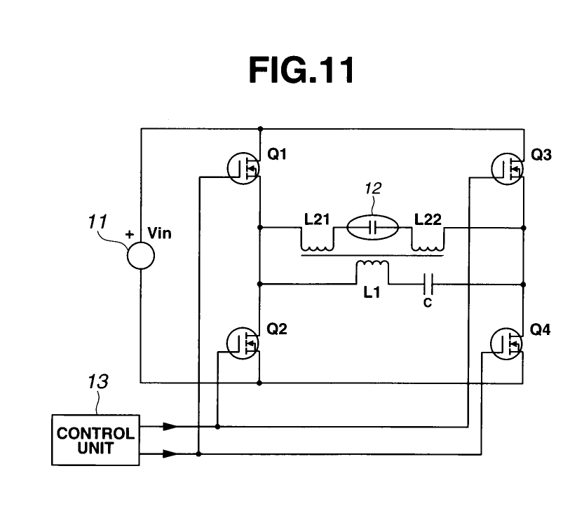

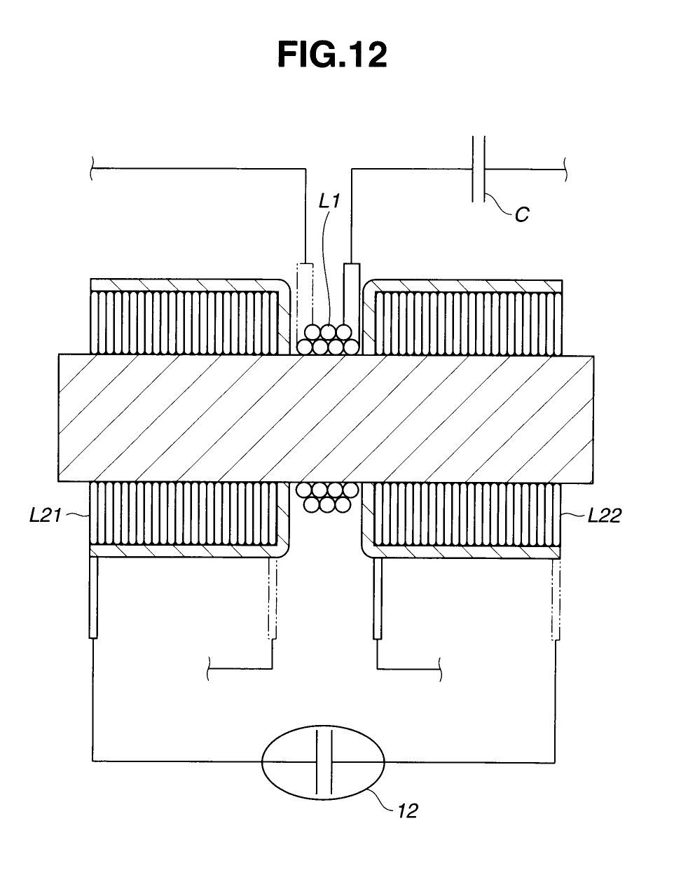

FIG. 11 is a circuit diagram illustrating a second embodiment of the present invention. FIG. 12 is a cross-sectional diagram describing the configuration of a coil. In FIGS. 11 and 12, the same composing elements as in FIG. 1 are denoted with the same reference numeral and characters to omit duplicated description.

The present embodiment is different from the first embodiment in that the secondary coil L2 out of the coils L1 and L2 configuring the transformer T in FIG. 1 is divided into coils L21 and L22. Both ends of the coils L21 and L22 are connected to the lamp 12. As is the case with the first embodiment, the coils L21 and L22 are formed of edgewise wound rectangular wires. As illustrated in FIG. 12, the configuration of the coils L21 and L22 is such that respective rectangular wires are wound edgewise at both ends of the same ferrite core 33. The coil L1 is formed such a manner that a magnet wire round in cross section is wound around the ferrite core 33 and between the coils L21 and L22.

In the present embodiment, the ratio of the number of turns of the coil L1 and the sum of the number of turns of the coils L21 and L22 may be properly determined to set the voltage across the terminals of the coils L21 and L22 to a sufficiently high voltage. This provides a sufficiently high voltage required for starting the lamp 12.

In the present embodiment, a voltage required for starting the lamp 12 may be divided by the coils L21 and L22 to generate voltages whose polarities are different from each other, so that the voltage generated in one coil can be halved. In other word, voltage to ground of each coil can be reduced to further decrease an adverse effect on peripheral elements.

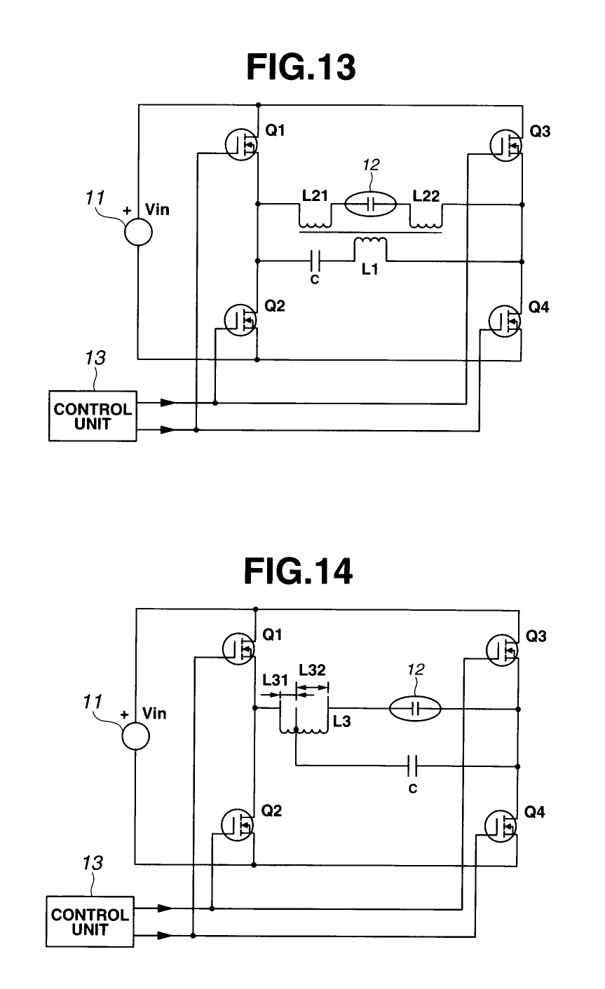

FIG. 13 is a circuit diagram illustrating a modification of the second embodiment. In FIG. 13, the same composing elements as in FIG. 11 are denoted with the same reference numeral and characters to omit duplicated description.

In the example of FIG. 13, the capacitor C arranged at one end of the coil L1 in FIG. 11 is arranged at the other end of the coil L1. In this case also, the first series circuit formed of the capacitor C and the coil L1 operates in the same manner as the capacitor C and the coil L1 in FIG. 11.

The other configuration and action are the same as those described in the embodiment in FIG. 11.

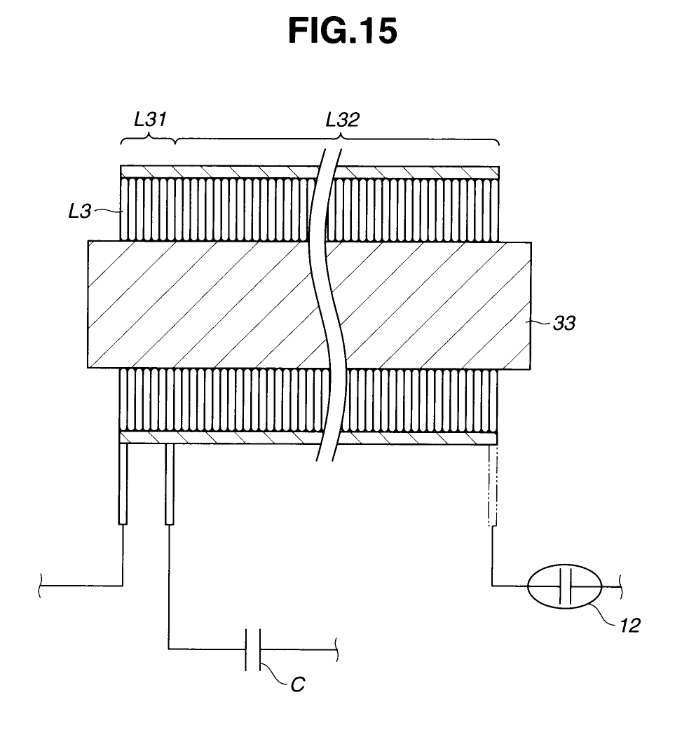

FIGS. 14 and 15 are circuit diagrams illustrating a third embodiment of the present invention. In FIGS. 14 and 15, the same composing elements as in FIG. 1 are denoted with the same reference numeral and characters to omit duplicated description.

The present embodiment is different from the first embodiment in that a coil L3 is used instead of the transformer T. One end of the capacitor C is connected to a second node of the second series circuit and the other end thereof is connected to the midpoint of the coil L3. As illustrated in FIG. 15, the coil L3 is formed of an edgewise wound rectangular wire as is the case with the coil L2 according to the first embodiment.

The ratio n2/n1 of the number of turns “n2” of a coil portion L32 between the midpoint of the coil L3 and the lamp 12 to the number of turns “n1” of a coil portion L31 between the midpoint of the coil L3 and the first node is set to be larger than 1.

The coil portion L31 of the coil L3 is connected in series to the capacitor C to form the first series circuit between the first and the second nodes. For this reason, the voltage across the capacitor C varies similarly to the capacitor C in the first embodiment at the time of starting. A voltage induced in the coil portion L32 according to the ratio of the number of turns, so that the same voltage as in FIG. 6 is applied across the lamp 12.

The other action is the same as that in the first embodiment.

Thus, the same effect as described in the first embodiment can be obtained also in the present embodiment.

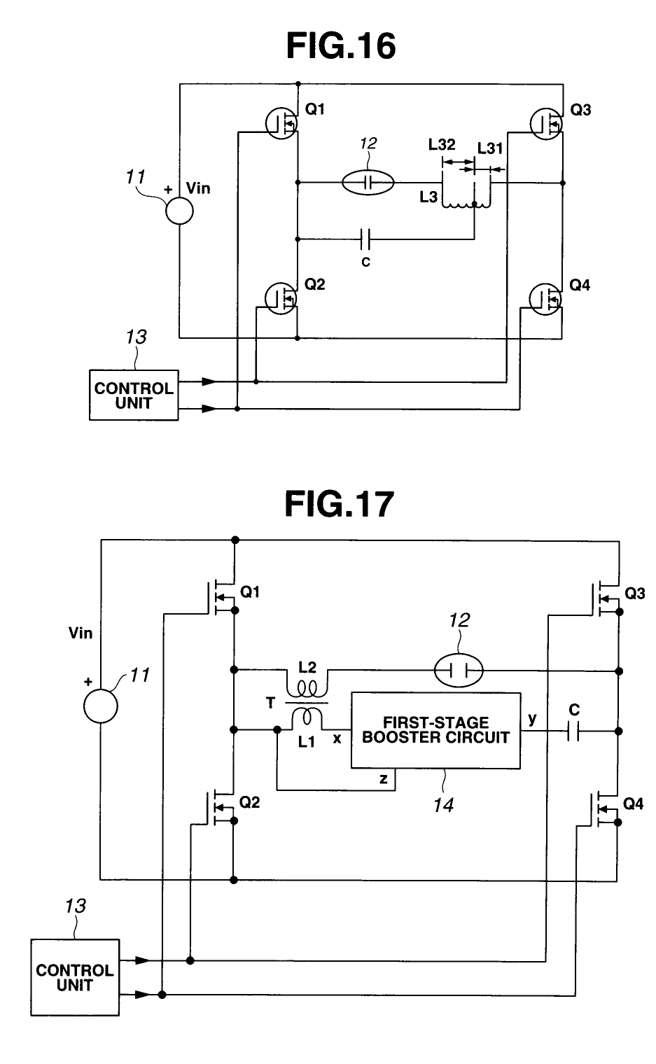

FIG. 16 is a circuit diagram illustrating a modification of the third embodiment. In FIG. 16, the same composing elements as in FIG. 14 are denoted with the same reference numeral and characters to omit duplicated description.

In the example of FIG. 16, the lamp 12 and the capacitor C are arranged on the side of the first node in FIG. 14 and the coil L3 is arranged on the side of the second node.

The other configuration and action are the same as those described in the embodiment in FIG. 14.

FIG. 17 is a circuit diagram illustrating a discharge lamp lighting device according to a fourth embodiment of the present invention. In FIG. 17, the same composing elements as in FIG. 1 are denoted with the same reference numeral and characters to omit duplicated description. The present embodiment uses a first-stage booster circuit to provide a voltage sufficiently higher than in the above embodiments at the time of starting.

The first node between the source of the transistor Q1 and the transistor Q2 is connected to the second node between the source of the transistor Q3 and the drain of the transistor Q4 through a first circuit unit including the coil L1, a first-stage booster circuit 14 and the capacitor C. The first-stage booster circuit 14 is connected to the coil L1 and the first node. A second circuit unit including the coil L2 and the lamp 12 is connected between the first and the second nodes. The HID lamp is used as the lamp 12.

For the sake of convenience of description, a node between the coil L1 and the first-stage booster circuit 14 is taken as “x,” a node between the first-stage booster circuit 14 and the capacitor C is taken as “y,” and a node between the first node and the first-stage booster circuit 14 is taken as “z.”

The capacitor C is provided to produce an oscillating waveform and limit current. The coils L1 and L2 form a transformer T. Incidentally, the coil L1 is taken as a primary of the transformer T and the coil L2 is taken as a secondary of the transformer T. In the present embodiment, the number of turns of the coil L2 is n times as many as that of the coil L1 (n is a positive number). The turns ratio “n” ranges from several times to several hundred times, for example.

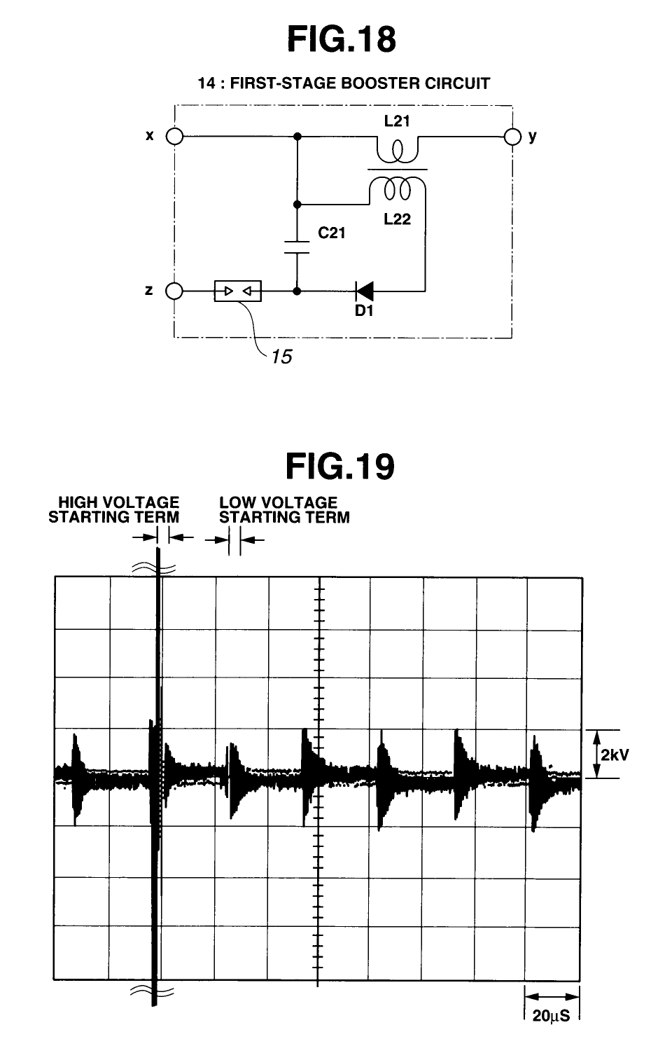

FIG. 18 is a circuit diagram illustrating one of concrete examples of the first-stage booster circuit 14 in FIG. 17.

A coil L21 is connected between the nodes x and y. A discharge gap 15 and the capacitor 21 are connected in series between the nodes x and y. A capacitor C21 is connected in parallel to the coil L22 and a diode D1. The coils L21 and L22 form a transformer.

A control unit 13 generates a control signal configured to drive the transistors Q1 to Q4. The control unit 13 turns on the transistors Q1 and Q4 and turns off the transistors Q2 and Q3. The control unit 13 turns off the transistors Q1 and Q4 and turns on the transistors Q2 and Q3. The control unit 13 varies an on-off switching frequency (a driving frequency) of the transistors Q1 to Q4 according to each phase at the time of lighting the lamp 12.

In other words, in the present embodiment, the control unit 13 drives the transistors Q1 to Q4 with a comparatively high frequency at the time of starting and preheating and drives the transistors Q1 to Q4 with a comparatively low frequency at the time of normal lighting.

The operation of thus configured discharge lamp lighting device according to the embodiment is described with reference to FIGS. 5 and 19 to 21. Also in the present embodiment, the discharge lamp lighting device operates according to the flow chart in FIG. 5 as is the case with the above embodiments.

### <Starting>

The power supply unit 11 supplies a positive polarity output to the power supply line and a negative polarity output to the reference potential line. A DC voltage applied across the power supply line and the reference potential line is supplied to the transistors Q1 to Q4 forming the bridge DC-AC converting circuit.

At the time of starting lighting the lamp 12, the process proceeds from step S1 to step S2 in FIG. 5 and the control unit 13 sets a first high frequency as the driving frequency of the transistors Q1 to Q4. The control unit 13 supplies the transistors Q1 to Q4 with the control signal with the first high frequency to turn on and off the transistors (step S3).

That is to say, the transistors Q1 and Q4 forming the bridge circuit are turned on and off at the same time, and the transistors Q2 and Q3 are also turned on and off at the same time. When the transistors Q1 and Q4 are turned on, the transistors Q2 and Q3 are turned off. When the transistors Q1 and Q4 are turned off, the transistors Q2 and Q3 are turned on. To prevent short-circuit, all the transistors Q1 to Q4 are turned off for a short time.

When the transistors Q1 and Q4 are turned on, the positive polarity output terminal of the power supply unit 11 causes current to flow to the negative polarity output terminal through the transistor Q1, the coil L1, (the coil L21) between nodes x and y of the first-stage booster circuit 14, the capacitor C, and the transistor Q4. When the transistors Q2 and Q3 are turned on, on the other hand, the positive polarity output terminal of the power supply unit 11 causes current to flow to the negative polarity output terminal through the transistor Q3, the capacitor C, (the coil L21) between nodes y and x of the first-stage booster circuit 14, the coil L1, and the transistor Q2.

When the transistors Q1 and Q4 are turned on, the capacitor C is charged through the coils L1 and L21 to increase the terminal voltage of the capacitor C substantially to the voltage Vin of the power supply unit 11. Then, a voltage VL+VL21 generated by counter electromotive force in the coils L1 and L21 is added to the voltage Vin to increase the terminal voltage of the capacitor C to Vin+VL+VL21. A free oscillation is generated between the coils L1 and L21 and the terminal voltage of the capacitor C converges at a predetermined value while changing polarities. When the transistors Q2 and Q3 are turned on, the same operation is performed as in the case where the transistors Q1 and Q4 are turned on.

In the present embodiment, a voltage generated in the coil L21 generates a voltage in the coil L22 according to the turns ratio.

The voltage in the coil L22 is rectified by the diode D1 and electric charges are stored in the capacitor C21. The capacitor C21 is repetitively charged each time the conduction path of the bridge circuit is switched (referred to as the polarity reversing operation of the bridge circuit) by the transistors Q1 and Q4 and the transistors Q2 and Q3 turning on and off. Thereby, the terminal voltage of the capacitor C21 is gradually increased. When the terminal voltage of the capacitor C21 reaches the gap voltage (GAP voltage) of a discharge gap 15, electric discharge is generated in the discharge gap 15 to cause current to flow through a loop of the capacitor C21, the discharge gap 15 and the coil L1, generating a sufficiently high lamp starting voltage in the coil L2 due to electromagnetic induction. The voltage generated in the coil L2 is applied to the lamp 12.

Since a voltage is generated in the coil L1 each time the polarity of the bridge circuit is reversed, a voltage is generated in the coil L2 according to turns ratio of the coil L2 to the coil L1 and applied across both ends of the lamp 12.

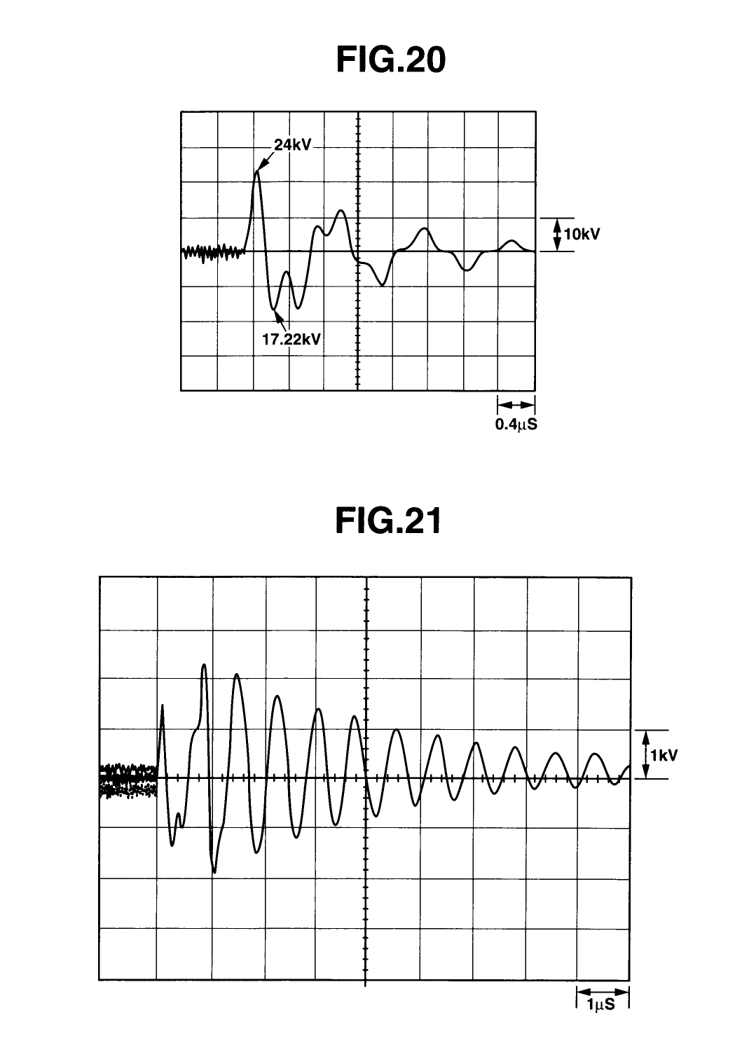

FIG. 19 is a waveform chart illustrating a voltage (a no-load starting voltage) across the lamp 12 at the time of starting with the abscissa as time and the ordinate as voltage. FIG. 20 is a waveform chart illustrating a voltage waveform (a high voltage starting waveform) in the lamp 12 in a high voltage starting term of FIG. 19 with the voltage axis being 5 times greater than that in FIG. 19 and the time base being 1/50 times greater than that in FIG. 19. FIG. 21 is a waveform chart illustrating a voltage waveform (a low voltage starting waveform) in the lamp 12 in a low voltage starting term of FIG. 19 with the voltage axis being ½ times greater than that in FIG. 19 and the time base being 1/20 times greater than that in FIG. 19. The low voltage starting waveform is generated each time the polarity of the bridge circuit is reversed.

The high voltage starting term in FIG. 19 includes a discharging term of the discharge gap 15. In the term, as illustrated in FIG. 20, an extremely high voltage is generated across the lamp 12 at the moment that the discharge gap 15 discharges. In the example of FIG. 20, the maximum voltage across the lamp 12 is approximately 24 kV and the minimum voltage is approximately −17.22 V. The extremely high voltage is applied to the lamp 12 each time the discharge gap 15 discharges. Frequencies of several hundred Hz to several hundred kHz may be used as the driving frequency at the time of starting.

Thus, turning on and off the transistors Q1 and Q4 and the transistors Q2 and Q3 is driven by the first high frequency to cause the first-stage booster circuit 14 to perform a boosting operation, increasing the terminal voltage of the capacitor C21. The boosting operation is synchronized with the polarity reversing operation of the bridge circuit. The capacitor C21 reaches the discharge gap voltage by the boosting operation repeated for several to several tens of thousand times, for example, and the discharge gap 15 discharges.

The discharge of the discharge gap 15 applies the voltage of the capacitor C21 to the coil L1 to generate a high voltage in the coil L2 due to the electromagnetic induction of the transformer T. The high voltage is applied to the lamp 12.

In a time different from the one during such a high voltage operation is conducted, a voltage applied to the coil L1 each time polarity of the bridge circuit is reversed is electromagnetically induced to the coil L2 according to turns ratio of the coil L2 to the coil L1. Thereby, a low voltage is generated across the lamp 12.

That is to say, in the present embodiment, a low voltage is generated in the coil L2 each time polarity of the bridge circuit is reversed and can be applied to the lamp 12. A high voltage is generated in the coil L2 in synchronization with the polarity reversing operation for several to several tens of thousand times and can be applied to the lamp 12. Even if the lamp 12 is not lighted by a low voltage generated in the coil L2, the polarity reversing operation is repeated to generate a high voltage in the coil L2, thereby surely lighting the lamp 12. Once the lamp 12 is lighted, such a comparatively high voltage as lighting the lamp 12 will not be generated in the coil L2 thereafter.

As described above, at the time of starting, the free oscillation operation of the coils L1 and L21 and the capacitor C generates the boosting operation in the capacitor C21 and generates the boosting operation in the transformer T during the polarity reversing operation of the bridge circuit. The voltage applied to the coil L21 at the time of the free oscillation is induced in the coil L22 by the boosting effect according to turns ratio of the coil L22 to the coil L21. The voltage is rectified by the diode D1 and stored in the capacitor C21. As described above, the free oscillation of the coils L1 and L21 and the C converges before the next reversion of the polarity to reduce current to substantially zero.

There are two voltages available starting the lamp 12: a low voltage which can be generated each time the polarity of the bridge circuit is reversed and a high voltage which can be generated each time the discharge gap discharges. In the present embodiment, therefore, it is enabled to start the lamp at a low voltage if the lamp can be easily started because temperature of the lamp is low, and it is also enabled to start the lamp at a high voltage if the lamp is hard to be started because temperature of the lamp is high.

### <Preheating>

The high voltage induced in the coil L2 is applied to the lamp 12 to cause the dielectric breakdown in the lamp 12. When the lamp 12 causes the dielectric breakdown by controlling the starting term, the lamp proceeds to a preheating term (step S4). The preheating term is a term during which an unstable discharge state immediately after discharge is started is transferred to stable discharge state.

The dielectric breakdown triggers off the glow discharge of the lamp 12, then to cause arc discharge, leading to normal lighting state. In the present embodiment, the lamp 12 is lighted by the energy of the power supply unit 11 during all the terms of the starting term, the preheating term and the normal lighting term.

At the time of preheating, a larger amount of lamp current is caused to flow to the lamp 12 to provide a stable discharge state in a short time. However, a large amount of lamp current damages the electrode of the lamp 12. For this reason, it is desirable to make a lamp current controllable at the time of preheating. In the present embodiment, the driving frequency of the transistors Q1 to Q4 is controlled to perform a preheating control.

Variation in lamp current at the time of preheating can be represented by waveform charts as is the case with FIGS. 8A and 8B. Specifically, also in the present embodiment, the lamp current becomes not an alternating current but a pulsating flow immediately after the preheating is started. Incidentally, the polarity can be reversed by reversely connecting the terminals of the lamp 12 to each other. The pulsating flow immediately after the start of preheating changes to alternating current as time passes. As frequencies increase from 8 kHz to 15 kHz at the time of preheating, a lamp current value decreases at the time of preheating. In addition, as frequencies increase from 8 kHz to 15 kHz at the time of preheating, it takes a longer time for the pulsating flow to change to alternating current. In other words, the smaller the current at the time of preheating, the longer the time during which the pulsating flow changes to alternating current.

Also in the present embodiment, judging from the above, it is probable that unstable charge is stabilized as time passes immediately after the start of discharge (start of preheating) to change to alternating current. In the preheating term, the larger the lamp current, the faster increase in temperature of inside gas or the electrode, the lamp quickly proceeds to a stable discharging state. The lamp current can be controlled by changing frequencies at the time of preheating. The lamp current is slightly saturated during the pulsating-flow interval. Sawtooth waveform lamp current with little distortion is obtained during the alternating current interval. The current peak value toward the same direction is smaller during the alternating current interval than during the pulsating-flow interval, so that the lamp current is hard to be saturated.

Also in the present embodiment, if a frequency slightly higher than 10 kHz is used as a frequency at the time of preheating, the peak value of the current at the time of preheating may be small and a preheating time may be comparatively long. Thus, properly controlling the frequency at the time of preheating enables preheating without damaging the lamp electrode.

### <Normal Lighting Term>

The preheating is terminated and the lamp is caused to proceed to a normal lighting term. In this case, the control unit 13 causes the process to proceed from step S6 to step S7 and sets the driving frequency of the transistors Q1 to Q4 to the frequency lower than that at the time of starting and preheating.

Current flows mainly through the coil L2 and the lamp 12 based on a rectangular waveform voltage generated by the DC-AC converting circuit formed of the transistors Q1 and Q4 in the normal lighting term. If the driving frequency becomes low, current will not continue flowing into the first circuit unit connected to the capacitor C. Consequently, the high and the low voltage in FIGS. 20 and 21 are not generated. Since the voltage Vin of the power supply unit 11 becomes low in the normal lighting term, current of the capacitor C in the first circuit unit is significantly reduced at the time of reversing the polarity. In the normal lighting term, the lamp 12 moves to stable arc discharge, providing stable lamp current.

Thus, in the present embodiment, the bridge DC-AC converting circuit using four transistors applies a rectangular waveform voltage across both ends of the first and the second circuit units connected in parallel to each other. A high voltage can be generated in the secondary coil according to the boosting operation of the first-stage booster circuit and the turns ratio of the secondary coil to the primary coil. When the starting term ends and then the preheating term begins, the driving frequency of the transistor is controlled to cause the lamp current to proceed to a stable discharge state without damaging a lamp electrode. For example, in a conventional high-voltage pulse starting system, an uncontrollable lamp rush current flows; however, the present embodiment can perform preheating while sufficiently suppressing the lamp rush current. This enables the lifetime of the lamp to be increased.

Furthermore, in the present embodiment, the polarity reversing operation is repeated to enable applying a high voltage to the lamp 12. If the lamp 12 is lighted at a low voltage, however, the high voltage is not generated. This enables suppressing the generation of noise.

Thus, a comparatively simple circuit enables a high voltage discharge lamp to be started and normally lighted and a simple starting circuit can be used, which are advantageous in terms of downsizing and cost reduction.

The control unit 13 may switch the starting term, the preheating term and the normal lighting term by time since the start of driving, for example.

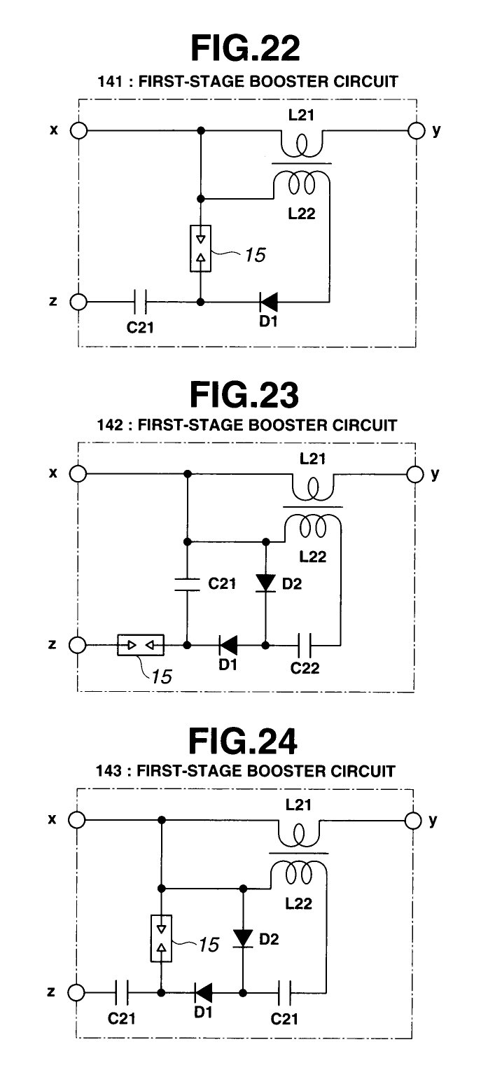

FIG. 22 is a circuit diagram illustrating a modification of the fourth embodiment. The modification uses a first-stage booster circuit 141 as the first-stage booster circuit instead of the first-stage booster circuit 14.

In the first-stage booster circuit 141, the capacitor C21 is replaced with the discharge gap 15 in position with respect to the first-stage booster circuit 14. In other words, the first-stage booster circuit 141 is different from the first-stage booster circuit 14 in charge and discharge paths of the capacitor C21.

The first-stage booster circuit 14 in FIG. 18 charges through the path including the coil L22, the diode D1 and the capacitor C21 and discharged through the path including the capacitor C21, the discharge gap 15 and the node z. On the other hand, the first-stage booster circuit 141 in FIG. 22 charges through the path including the coil L22, the diode D1, the capacitor C21, the coil L1, the node x and the coil L22 and discharges through the path including the capacitor C21, the discharge gap 15, the node x, the coil L1 and the node z.

The other configuration and action are the same as those described in the fourth embodiment.

FIG. 23 is a circuit diagram illustrating a fifth embodiment of the present invention. In FIG. 23, the same composing elements as in FIG. 18 are denoted with the same reference numeral and characters to omit duplicated description.

The present embodiment is different from the fourth embodiment in that a first-stage booster circuit 142 to which a capacitor C22 and a diode D2 for boosting are added is employed. One end of the coil L22 is connected to the anode of the diode D1 through the capacitor C22 and the other end of the coil L22 is connected to the anode of the diode D1 through the diode D2. That is to say, a voltage doubler circuit is made up of the capacitor C22 and the diode D2.

The capacitor C22 is charged through the coil L22 and the diode D2. The voltage generated in the coil L22 is also applied across the capacitor C22. A voltage in which the voltage generated in the coil L22 is doubled is applied to the node between the capacitor C22 and the diode D1. This causes the terminal voltage of the capacitor C21 to reach the discharge gap voltage in a comparatively short time.

Thus, in the present embodiment, the use of the voltage doubler circuit allows the capacitor C21 to be surely charged to the discharge gap voltage even if the transformer formed of the coils L21 and L22 is low in performance not to provide a sufficient voltage.

FIG. 24 is a circuit diagram illustrating a modification of the fifth embodiment of the present invention. The modification uses a first-stage booster circuit 143 as the first-stage booster circuit instead of the first-stage booster circuit 142.

In the first-stage booster circuit 143, the capacitor C21 is replaced with the discharge gap 15 in position with respect to the first-stage booster circuit 142. In other words, the first-stage booster circuit 143 is different from the first-stage booster circuit 142 only in charge and discharge paths of the capacitor C21.

The other configuration and action are the same as those described in the fifth embodiment.

Although the above embodiments show the examples using the bridge DC-AC converting circuit as a DC-AC converting circuit, it is obvious that a half bridge DC-AC converting circuit can be used.

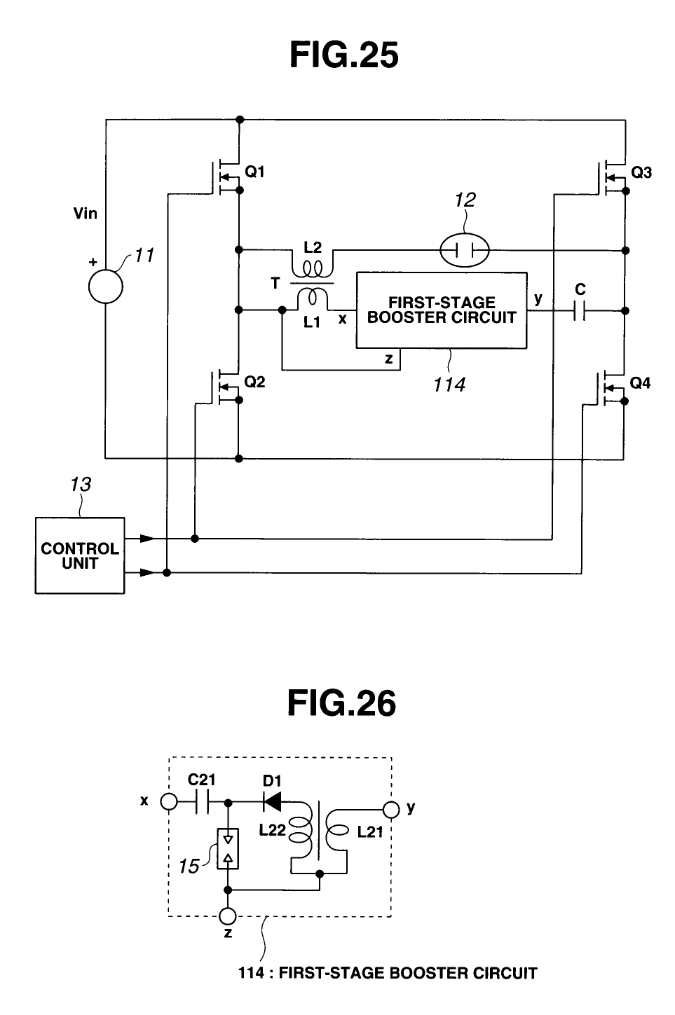

FIG. 25 is a circuit diagram illustrating a discharge lamp lighting device according to a sixth embodiment of the present invention. In FIG. 25, the same composing elements as in FIG. 17 are denoted with the same reference numeral and characters to omit duplicated description.

The present embodiment is different from the fourth embodiment in that the first-stage booster circuit 14 is replaced with a first-stage booster circuit 114.

FIG. 26 is a circuit diagram illustrating one of concrete examples of the first-stage booster circuit 114 in FIG. 25.

The node z is directly connected to the first node and to the node y through the coil L21. The node y is connected to the second node through the capacitor C. This means that the coil L21 is connected in series to the capacitor C between the first and the second nodes. The node z is connected to the node x through the coil L22, the diode D1 and the capacitor C21. The node x is connected to the first node through the coil L1. The node between the diode D1 and the capacitor C21 is connected to the node z through the discharge gap 15. The coils L21 and L22 form a transformer.

Also in the present embodiment, the control unit 13 drives the transistors Q1 to Q4 with a comparatively high frequency at the time of starting and preheating and drives the transistors Q1 to Q4 with a comparatively low frequency at the time of normal lighting.

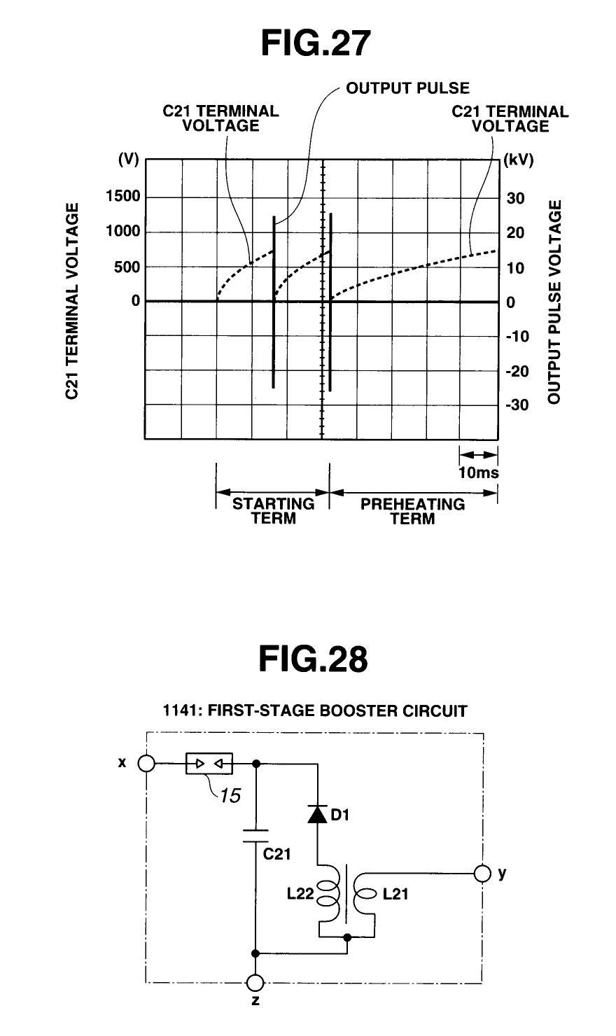

The operation of thus configured discharge lamp lighting device according to the embodiment is described with reference to the waveform chart in FIG. 27. Also in the present embodiment, the discharge lamp lighting device operates according to the flow chart in FIG. 5.

At the time of starting, the power supply unit 11 supplies a positive polarity output to the power supply line and a negative polarity output to the reference potential line. A DC voltage applied across the power supply line and the reference potential line is supplied to the transistors Q1 to Q4 forming the bridge DC-AC converting circuit.

At the time of starting lighting the lamp 12, the process proceeds from step S1 to step S2 in FIG. 5 and the control unit 13 sets a first high frequency as the driving frequency of the transistors Q1 to Q4. The transistors Q1 to Q4 turn on and off according to the control signal (step S3).

When the transistors Q1 and Q4 are turned on, the positive polarity output terminal of the power supply unit 11 causes current to flow to the negative polarity output terminal through the transistor Q1, (the coil L21) between nodes z and y of the first-stage booster circuit 114, the capacitor C, and the transistor Q4. When the transistors Q2 and Q3 are turned on, on the other hand, the positive polarity output terminal of the power supply unit 11 causes current to flow to the negative polarity output terminal through the transistor Q3, the capacitor C, (the coil L21) between nodes y and z of the first-stage booster circuit 114, and the transistor Q2.

When the transistors Q1 and Q4 are turned on, the capacitor C is charged through the coil L21 in the first-stage booster circuit 114 to increase the terminal voltage of the capacitor C substantially to the voltage Vin of the power supply unit 11. Then, a voltage VL21 generated in the coil L21 by counter electromotive force in the coil L21 is added to the voltage Vin to increase the terminal voltage of the capacitor C to Vin+VL21. A free oscillation is generated between the coil L21 and the capacitor C and the terminal voltage of the capacitor C converges at a predetermined value while changing polarities. When the transistors Q2 and Q3 are turned on, the same operation is performed as in the case where the transistors Q1 and Q4 are turned on.

In the present embodiment, a voltage generated in the coil L21 generates a voltage in the coil L22 according to the turns ratio.

One end of the coil L21 on the primary side is connected to the coil L22. A voltage in which a voltage according to the turns ratio of the coil L22 to the coil L21 by electromagnetic coupling is added to a voltage generated in the coil L21 appears on the terminal voltage of the coil L22.

The voltage in the coil L22 is rectified by the diode D1 and electric charges are stored in the capacitor C21. The capacitor C21 is charged through a charging path including the coil L22, the diode D1, the capacitor C21, the coil L1 and the node z.

The capacitor C21 is repetitively charged each time the transistors Q1 and Q4 and the transistors Q2 and Q3 are turned on and off to reverse the polarity of the bridge circuit. When the terminal voltage of the capacitor C21 reaches the gap voltage (GAP voltage) of a discharge gap 15, electric discharge is generated in the discharge gap 15 to cause current to flow through a loop of the capacitor C21, the discharge gap 15 and the coil L1, generating a sufficiently high lamp starting voltage in the coil L2 due to electromagnetic induction. The voltage generated in the coil L2 is applied to the lamp 12.

FIG. 27 is a waveform chart illustrating the terminal voltage (broken line) of the capacitor C21 and a voltage (solid line) applied across the lamp 12 at the time of starting with the abscissa as time and the ordinate as voltage. In FIG. 27, the ordinate is scaled in voltages of 500 V/scale with respect to the terminal voltage of the capacitor C21 and of 10 kV/scale with respect to the output pulse. FIG. 27 also indicates the terminal voltage of the capacitor C21 generated after the lamp 12 is lighted by two output pulses. The time axis of FIG. 27 is expanded to provide the same waveform chart as that shown in FIG. 20.

The capacitor C21 is charged by the polarity reversing operation of the bridge circuit to cause the terminal voltage of the capacitor C21 to reach the charge gap voltage, thereby the output pulse appears on the coil L2, as illustrated in FIGS. 27 and 20. In other words, an extremely high voltage is generated across the lamp 12 at the moment that the discharge gap 15 discharges.

Thus, turning on and off the transistors Q1 and Q4 and the transistors Q2 and Q3 is driven by the first high frequency to cause the first-stage booster circuit 114 to perform a boosting operation, increasing the terminal voltage of the capacitor C21. The boosting operation is synchronized with the polarity reversing operation of the bridge circuit. The capacitor C21 reaches the discharge gap voltage by the boosting operation repeated for several to several tens of thousand times, for example, and the discharge gap 15 discharges.

That is to say, in the present embodiment, the capacitor C21 is repetitively charged each time the polarity of the bridge circuit is reversed. When the terminal voltage of the capacitor C21 exceeds the discharge gap voltage, an extremely high voltage is generated in the coil L2 to light the lamp 12.

Hereinafter, the lamp proceeds to a preheating term, then current flowing through the first circuit unit is reduced to increase charging time of the capacitor 21, and charge and discharge are repeated. After that, when the lamp proceeds to a normal lighting state, current flowing through the first circuit unit is sufficiently reduced, and such a comparatively high voltage as lighting the lamp 12 will not be generated in the coil L2.

Thus, at the time of starting, the free oscillation operation of the coil L21 and the capacitor C generates the boosting operation in the capacitor C21 during the polarity reversing operation of the bridge circuit. The voltage applied to the coil L21 at the time of the free oscillation is induced in the coil L22 by the boosting effect according to turns ratio of the coil L22 to the coil L21. The voltage is rectified by the diode D1 and stored in the capacitor C21. As described above, the free oscillation of the coil L21 and the C converges before the next reversion of the polarity to reduce current to substantially zero.

Also in the present embodiment, preheating control is the same as that in the above embodiments. The driving frequency of the transistors Q1 to Q4 is controlled to perform the preheating control. The operation in the normal lighting term is also the same as that in the above embodiments. The driving frequency of the transistors Q1 to Q4 is set to a frequency lower than that at the time of starting and preheating.

Thus, the same effect as described in the above embodiments can be obtained also in the present embodiment.

Furthermore, in the present embodiment, the polarity reversing operation is repeated by the bridge circuit to continuously charge the capacitor in the first-stage booster circuit. The terminal voltage of the capacitor exceeding the discharge gap voltage enables applying an extremely high voltage to the lamp 12. This further ensures the lighting of the lamp 12.

Thus, a comparatively simple circuit enables a high voltage discharge lamp to be started and normally lighted and a simple starting circuit can be used, which are advantageous in terms of downsizing and cost reduction.

FIG. 28 is a circuit diagram illustrating a first modification of the embodiment in FIG. 25. The first modification uses a first-stage booster circuit 1141 as the first-stage booster circuit instead of the first-stage booster circuit 114.

In the first-stage booster circuit 1141, the capacitor C21 is replaced with the discharge gap 15 in position with respect to the first-stage booster circuit 1114. In other words, the first-stage booster circuit 1141 is different from the first-stage booster circuit 114 in charge and discharge paths of the capacitor C21.

In the first-stage booster circuit 114 in FIG. 26, the capacitor C21 is charged through the path including the coil L22, the diode D1 and the capacitor C21 and discharged through the path from the capacitor C21 to the discharge gap 15 and the node z. On the other hand, in the first-stage booster circuit 1141 in FIG. 28, the capacitor C21 is charged through the path including the coil L22, the diode D1 and the node z and discharged through the path from the discharge gap 15 to the capacitor C21.

The other configuration and action are the same as those described in the embodiment in FIG. 25.

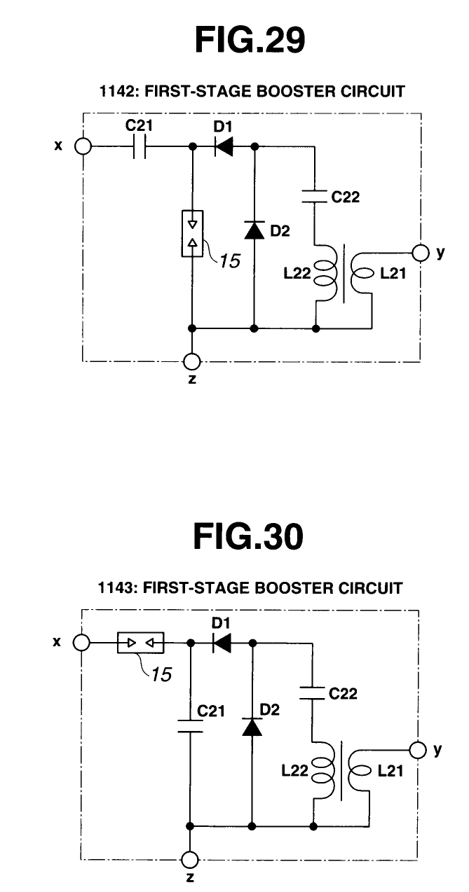

FIG. 29 is a circuit diagram illustrating a second modification. In FIG. 29, the same composing elements as in FIG. 26 are denoted with the same reference numeral and characters to omit duplicated description.

The second modification is different from the first-stage booster circuit 114 in FIG. 26 in that a first-stage booster circuit 1142 to which a capacitor C22 and a diode D2 for boosting are added is employed. One end of the coil L22 is connected to the anode of the diode D1 through the capacitor C22 and the other end of the coil L22 is connected to the anode of the diode D1 through the diode D2. That is to say, a voltage doubler circuit is made up of the capacitor C22 and the diode D2.

The capacitor C22 is charged through the coil L22 and the diode D2. The voltage generated in the coil L22 is also applied across the capacitor C22. A voltage in which the voltage generated in the coil L22 is doubled is applied to the node between the capacitor C22 and the diode D1. This causes the terminal voltage of the capacitor C21 to reach the discharge gap voltage in a comparatively short time.

Thus, in the second modification, the use of the voltage doubler circuit allows the capacitor C21 to be surely charged to the discharge gap voltage even if the transformer formed of the coils L21 and L22 is low in performance not to provide a sufficient voltage.

FIG. 30 is a circuit diagram illustrating a third modification. The modification uses a first-stage booster circuit 1143 as the first-stage booster circuit instead of the first-stage booster circuit 1142.

In the first-stage booster circuit 1143, the capacitor C21 is replaced with the discharge gap 15 in position with respect to the first-stage booster circuit 1142. In other words, the first-stage booster circuit 1143 is different from the first-stage booster circuit 1142 only in charge and discharge paths of the capacitor C21.

The other configuration and action are the same as those described in the second modification.

Although the above embodiments show the examples using the bridge DC-AC converting circuit as a DC-AC converting circuit, it is obvious that a half bridge DC-AC converting circuit can be used.

This application is to claim a priority based on Japanese Patent Application No. 2006-198591, filed on Jul. 20, 2006, Japanese Patent Application No. 2006-260565, filed on Sep. 26, 2006 and Japanese Patent Application No. 2006-260566, filed on Sep. 26, 2006 and the disclosure of which is totally incorporated in the description, claims and drawings of the application.

1. A discharge lamp lighting device comprising:
a first series circuit unit in which a primary coil is connected in series to a capacitor;
a second series circuit unit in which a secondary coil is connected in series to a discharge lamp, the secondary coil being a winding wound on the side portion of a rod-shaped magnetic core along the axial direction of the magnetic core, being greater in the number of turns than the primary coil, being smaller in dimension of its cross section parallel to the axial direction of the magnetic core than in dimension of its cross section in the radial direction of the magnetic core and forming a transformer along with the primary coil; and
a bridge DC-AC converting circuit which includes four transistors, converts DC voltage supplied from a power supply unit to AC voltage and supplies the AC voltage to both ends of the first and the second series circuit units connected in parallel to each other.

2. The discharge lamp lighting device according to claim 1, wherein
the second series circuit unit is formed in such a manner that the secondary coil is divided and provided between both ends of the discharge lamp.

3. A discharge lamp lighting device comprising:
a series circuit unit formed such a manner that a coil formed by winding a winding is connected in series to a discharge lamp;
a capacitor connected in parallel to the discharge lamp between one end of the series circuit unit and the midpoint of the coil; and
a bridge DC-AC converting circuit which includes four transistors, converts DC voltage supplied from a power supply unit to AC voltage and supplies AC voltage to both ends of the series circuit unit; wherein
the midpoint is set to a point where the number of turns of the coil on one end side of the series circuit unit is greater than the number of turns of the coil on the other end side.

4. The discharge lamp lighting device according to claim 1, wherein
the winding is square in cross section and wound in such a manner that the inner face of the winding is parallel to the side portion of the magnetic core.

5. The discharge lamp lighting device according to claim 2, wherein
the winding is square in cross section and wound in such a manner that the inner face of the winding is parallel to the side portion of the magnetic core.

6. The discharge lamp lighting device according to claim 3, wherein
the winding is square in cross section and wound in such a manner that the inner face of the winding is parallel to the side portion of the magnetic core.

7. The discharge lamp lighting device according to claim 1, wherein
the winding has a flat cross section whose dimensions in two directions orthogonal to each other are different on the cross section of the plane orthogonal to the central axis of the winding and is wound so that the longitudinal direction of the cross section is along the radial direction of the magnetic core.

8. The discharge lamp lighting device according to claim 2, wherein
the winding has a flat cross section whose dimensions in two directions orthogonal to each other are different on the cross section of the plane orthogonal to the central axis of the winding and is wound so that the longitudinal direction of the cross section is along the radial direction of the magnetic core.

9. The discharge lamp lighting device according to claim 3, wherein
the winding has a flat cross section whose dimensions in two directions orthogonal to each other are different on the cross section of the plane orthogonal to the central axis of the winding and is wound so that the longitudinal direction of the cross section is along the radial direction of the magnetic core.

10. The discharge lamp lighting device according to claim 7, wherein
the winding is a rectangular wire.

11. The discharge lamp lighting device according to claim 8, wherein
the winding is a rectangular wire.

12. The discharge lamp lighting device according to claim 9, wherein
the winding is a rectangular wire.

13. The discharge lamp lighting device according to claim 1, further comprising a control unit configured to drive the DC-AC converting circuit at a first frequency at the time of starting, drive the DC-AC converting circuit at a second frequency being the same as or different from the first frequency at the time of preheating following the starting and drive the DC-AC converting circuit at a third frequency being lower than the first and the second frequencies at the time of normal lighting following the preheating.

14. The discharge lamp lighting device according to claim 2, further comprising a control unit configured to drive the DC-AC converting circuit at a first frequency at the time of starting, drive the DC-AC converting circuit at a second frequency being the same as or different from the first frequency at the time of preheating following the starting and drive the DC-AC converting circuit at a third frequency being lower than the first and the second frequencies at the time of normal lighting following the preheating.

15. The discharge lamp lighting device according to claim 3, further comprising a control unit configured to drive the DC-AC converting circuit at a first frequency at the time of starting, drive the DC-AC converting circuit at a second frequency being the same as or different from the first frequency at the time of preheating following the starting and drive the DC-AC converting circuit at a third frequency being lower than the first and the second frequencies at the time of normal lighting following the preheating.

16. A discharge lamp lighting device comprising:
a first circuit unit including a first primary coil, a second primary coil and a first capacitor which are connected in series to one another;
a second circuit unit in which a first secondary coil is connected in series to a discharge lamp, the first secondary coil forming a transformer along with the first primary coil and being greater in the number of turns than the first primary coil;
a DC-AC converting circuit configured to convert DC voltage supplied from a power supply unit to AC voltage and supply the AC voltage to both ends of the first and the second circuit units connected in parallel to each other;
a second secondary coil which is included in the first circuit unit, forms a transformer along with the second primary coil and is greater in the number of turns than the second primary coil;
a second capacitor which is included in the first circuit unit and to which the voltage generated in the second secondary coil is applied through a charging path; and
a discharge gap which is included in the first circuit unit, conducted by the terminal voltage of the second capacitor reaching the discharge gap voltage and supplies the terminal voltage of the second capacitor to the first primary coil through a discharging path.

17. The discharge lamp lighting device according to claim 16, further comprising a control unit configured to drive the DC-AC converting circuit at a first frequency at the time of starting, drive the DC-AC converting circuit at a second frequency being the same as or different from the first frequency at the time of preheating following the starting and drive the DC-AC converting circuit at a third frequency being lower than the first and the second frequencies at the time of normal lighting following the preheating.

18. A discharge lamp lighting device comprising:
a first circuit unit configured to generate a desired voltage as polarity is reversed to supply the voltage to a primary coil;
a second circuit unit formed in such a manner that a secondary coil forming a transformer along with the primary coil and being greater in the number of turns than the primary coil is connected in series to a discharge lamp, and connected in parallel to the first circuit unit;
a DC-AC converting circuit configured to convert DC voltage supplied from a power supply unit to AC voltage and supply the AC voltage to both ends of the first and the second circuit units connected in parallel to each other; and
a control unit configured to control the DC-AC converting circuit to continuously supply the AC voltage to the first circuit unit.

19. The discharge lamp lighting device according to claim 18, wherein
the control unit controls the DC-AC converting circuit to drive the DC-AC converting circuit at a first frequency at the time of starting, drive the DC-AC converting circuit at a second frequency being the same as or different from the first frequency at the time of preheating following the starting and drive the DC-AC converting circuit at a third frequency being lower than the first and the second frequencies at the time of normal lighting following the preheating.
